(19) United States
(12) Patent Application Publication
(10) Pub. No.: US 2009/0181761 A1
(43) Pub. Date: Jul. 16, 2009

(54) GAMING MACHINE IN WHICH BET IS MADE FOR VARIOUS EVENTS AND PLAYING METHOD THEREOF

(75) Inventor: Kazumasa Yoshizawa, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: ARUZE CORP., Tokyo (JP)

(21) Appl. No.: 12/175,187

(22) Filed: Jul. 17, 2008

Related U.S. Application Data
(60) Provisional application No. 61/020,803, filed on Jan. 14, 2008.

(51) Int. Cl. A63F 13/00; A63F 9/24

(52) U.S. Cl. 463/25; 463/31; 463/37

(57) ABSTRACT

The present sportsbook machine 1 is a gaming machine operable under control of a controller 100, and includes a display 110 and a touch panel 120. The display 110 displays thereon several betting objects selectable as a result of various events. By the touch panel 120, a regular bet on the betting object, and a bonus bet on the betting object which is different in payout rate from the regular bet can be inputted from outside, as designated operations corresponding to the respective bets. The controller 100 is programmed so as to: set a payout rate for the regular bet and a payout rate for the bonus bet, with respect to each of the betting objects; receive the regular bet or the bonus bet on the betting object as a player's bet, based on a designated operation inputted into the touch panel 120; determine whether the result of the event is consistent with the betting object or not; give the player an event payout based on the player's bet, when it has been determined that the result of the event is consistent with the betting object; determine based on a predetermined condition whether a bonus payout which is different from the event payout should be given or not, when the player's bet is the bonus bet and the event payout has been given; and give the player the bonus payout, when it has been determined that the bonus payout should be given.

### CROSS REFERENCE TO RELATED APPLICATION

This application claims the benefit of U.S. Provisional Application No. 61/020,803, filed on Jan. 14, 2008, which application is incorporated herein by reference in its entirety.

### BACKGROUND OF THE INVENTION

1. Field of the Invention

The present invention relates to a gaming machine and a playing method thereof, and more specifically to a gaming machine in which a bet is made for results of various events and a playing method thereof.

2. Description of Related Art

Conventionally, in a gaming machine of this type, betting objects in a game played by a player are a result of various events such as sports. The player bets a game value such as a coin, a bill, an electronic medium, and the like, on the betting objects of the various events. Based on the result of the various events and the game value bet, the gaming machine pays a game value back to the player.

This type of gaming machine is disclosed in specification of U.S. Patent Application Publication No. 2005079910A1. According to the gaming machine disclosed in the specification, two kinds of bets, that is, a card game and a book game, can be made. However, it is impossible to enjoy both of the games at one time. In addition, this involves a player's concentration problem which may reduce player's motivation to continue the game.

Thus, an object of the present invention is to provide a slot machine which can offer a player new entertainmentness unobtainable from the above-mentioned prior art, and a playing method thereof.

More specifically, an object is to provide a player with a variety of entertainmentness upon one bet, instead of entertaining the player separately with two kinds of bets as in the conventional gaming machines of this type.

### SUMMARY OF THE INVENTION

According to an aspect of the present invention, there is provided a gaming machine comprising a display, an input device, and a controller. The display displays thereon a plurality of betting objects selectable as a result of various events. By the input device, a regular bet on the betting object, and a bonus bet on the betting object which is different in payout rate from the regular bet can be inputted from outside, as designated operations corresponding to the respective bets. The controller is programmed to operate in the following steps of: (a1) setting a payout rate for the regular bet and a payout rate for the bonus bet, with respect to each of the betting objects; (a2) receiving the regular bet or the bonus bet on the betting object as a player's bet, based on a designated operation inputted into the input device; (a3) determining whether the result of the event is consistent with the betting object or not; (a4) giving the player a first payout based on the player's bet, when it has been determined that the result of the event is consistent with the betting object; (a5) determining based on a predetermined condition whether a second payout which is different from the first payout should be given or not, when the player's bet is the bonus bet and the first payout has been given; and (a6) giving the player the second payout, when it has been determined that the second payout should be given.

In a structure described above, a plurality of betting objects which are selectable as a result of various events are displayed on the display. A regular bet on the betting object, and a bonus bet on the betting object which is different in payout rate from the regular bet can be inputted from outside, by performing, on the input device, designated operations corresponding to the respective bets. A payout rate for the regular bet and a payout rate for the bonus bet are set with respect to each of the betting objects. Based on a designated operation inputted into the input device by a player, the regular bet or the bonus bet on the betting object is received as a player's bet. Whether the result of the event is consistent with the betting object or not is determined. When it has been determined that the result of the event is consistent with the betting object, a first payout based on the player's bet is given to the player. When the player's bet is the bonus bet and the first payout has been given, whether a second payout which is different from the first payout should be given or not is determined based on a predetermined condition. When it has been determined that the second payout should be given, the second payout is given to the player.

Therefore, simply by performing on the input device the designated operation corresponding to the bonus bet, the player can expect not only the first payout as a regular game result but also the second payout which can be given depending on determination based on the predetermined condition. This offers the player new entertainmentness.

According to an aspect of the present invention, there is provided a gaming machine comprising a display, an input device, and a controller. The display displays thereon a plurality of betting objects selectable as a result of various events. By the input device, a regular bet on the betting object, and a bonus bet on the betting object which has a payout rate lower than the payout rate of the regular bet can be inputted from the outside, as designated operations corresponding to the respective bets. The controller is programmed to operate in the following steps of: (b1) setting a payout rate for the regular bet and a payout rate for the bonus bet, with respect to each of the betting objects; (b2) receiving the regular bet or the bonus bet on the betting object as a player's bet, based on a designated operation inputted into the input device; (b3) determining whether the result of the event is consistent with the betting object or not; (b4) giving the player a first payout based on the player's bet, when it has been determined that the result of the event is consistent with the betting object; (b5) determining at random whether a second payout which is different from the first payout should be given or not, when the player's bet is the bonus bet and the first payout has been given; and (b6) giving the player the second payout, when it has been determined that the second payout should be given.

In a structure described above, a plurality of betting objects which are selectable as a result of various events are displayed on the display. A regular bet on the betting object, and a bonus bet on the betting object which has a payout rate lower than the payout rate of the regular bet can be inputted from outside, by performing, on the input device, designated operations corresponding to the respective bets. A payout rate for the regular bet and a payout rate for the bonus bet are set with respect to each of the betting objects. Based on a designated operation inputted into the input device by a player, the regular bet or the bonus bet on the betting object is received as a player's bet. Whether the result of the event is consistent with the betting object or not is determined. When it has been determined that the result of the event is consistent with the betting object, a first payout based on the player's bet is given to the player. When the player's bet is the bonus bet and the first payout has been given, whether a second payout which is different from the first payout should be given or not is determined at random. When it has been determined that the second payout should be given, the second payout is given to the player.

Therefore, simply by performing on the input device the designated operation corresponding to the bonus bet, the player can expect not only the first payout as a regular game result but also the second payout which can be given depending on random determination. The payout rate for the bonus bet (so-called odds) is set lower than the payout rate for the regular bet. Accordingly, even when the second payout is given, reduction in profits of the manager side of the gaming machine can be suppressed. Like this, new entertainmentness can be provided to the player, while suppressing reduction in manager-side's profits.

According to an aspect of the present invention, there is provided a gaming machine comprising a display, an input device, and a controller. The display displays thereon a plurality of betting objects selectable as a result of various events. By the input device, a regular bet on the betting object, and a bonus bet on the betting object which is different in payout rate from the regular bet can be inputted from outside, as designated operations corresponding to the respective bets. The controller is programmed to operate in the following steps of: (c1) setting a payout rate for the regular bet and a payout rate for the bonus bet, with respect to each of the betting objects; (c2) receiving the regular bet or the bonus bet on the betting object as a player's bet, based on a designated operation inputted into the input device; (c3) determining whether the result of the event is consistent with the betting object or not; (c4) storing a determination result as a win/lose history; (c5) giving the player a first payout based on the player's bet, when it has been determined that the result of the event is consistent with the betting object; (c6) determining based on a predetermined condition whether a second payout which is different from the first payout should be given or not, when the player's bet is the bonus bet and the first payout has been given; and (c7) giving the player the second payout based on the win/lose history, when it has been determined that the second payout should be given.

In a structure described above, a plurality of betting objects which are selectable as a result of various events are displayed on the display. A regular bet on the betting object, and a bonus bet on the betting object which is different in payout rate from the regular bet can be inputted from outside, by performing, on the input device, designated operations corresponding to the respective bets. A payout rate for the regular bet and a payout rate for the bonus bet are set with respect to each of the betting objects. Based on a designated operation inputted into the input device by a player, the regular bet or the bonus bet on the betting object is received as a player's bet. Whether the result of the event is consistent with the betting object or not is determined. A determination result is stored as a win/lose history. When it has been determined that the result of the event is consistent with the betting object, a first payout based on the player's bet is given to the player. When the player's bet is the bonus bet and the first payout has been given, whether a second payout which is different from the first payout should be given or not is determined based on a predetermined condition. When it has been determined that the second payout based on the win/lose history should be given, the second payout is given to the player.

Therefore, simply by performing on the input device the designated operation corresponding to the bonus bet, the player can expect not only the first payout as a regular game result but also the second payout which can be given depending on determination based on the predetermined condition. Since the second payout is based on the win/lose history, it is sometimes possible to improve player's motivation to continue the game, depending on a game history of the gaming machine. Consequently, new entertainmentness can be provided to the player, while improving manager-side's profits by making the player continue the game.

According to an aspect of the present invention, there is provided a gaming machine comprising a display, an input device, and a controller. The display displays thereon a plurality of betting objects selectable as a result of various events. By the input device, a regular bet on the betting object, and a bonus bet on the betting object which has a payout rate lower than the payout rate of the regular bet can be inputted from the outside, as designated operations corresponding to the respective bets. The controller is programmed to operate in the following steps of: (d1) setting a payout rate for the regular bet and a payout rate for the bonus bet, with respect to each of the betting objects; (d2) receiving the regular bet or the bonus bet on the betting object as a player's bet, based on a designated operation inputted into the input device; (d3) determining whether the result of the event is consistent with the betting object or not; (d4) storing a determination result as a win/lose history; (d5) giving the player a first payout based on the player's bet, when it has been determined that the result of the event is consistent with the betting object; (d6) determining at random whether a second payout which is different from the first payout should be given or not, when the player's bet is the bonus bet and the first payout has been given; and (d7) giving the player the second payout based on the win/lose history, when it has been determined that the second payout should be given.

In a structure described above, a plurality of betting objects which are selectable as a result of various events are displayed on the display. A regular bet on the betting object, and a bonus bet on the betting object which has a payout rate lower than the payout rate of the regular bet can be inputted from outside, by performing, on the input device, designated operations corresponding to the respective bets. A payout rate for the regular bet and a payout rate for the bonus bet are set with respect to each of the betting objects. Based on a designated operation inputted into the input device by a player, the regular bet or the bonus bet on the betting object is received as a player's bet. Whether the result of the event is consistent with the betting object or not is determined. A determination result is stored as a win/lose history. When it has been determined that the result of the event is consistent with the betting object, a first payout based on the player's bet is given to the player. When the player's bet is the bonus bet and the first payout has been given, whether a second payout which is different from the first payout should be given or not is determined at random. When it has been determined that the second payout should be given, the second payout based on the win/lose history is given to the player.

Therefore, simply by performing on the input device the designated operation corresponding to the bonus bet, the player can expect not only the first payout as a regular game result but also the second payout which can be given depending on random determination. In addition, the payout rate for the bonus bet (so-called odds) is set lower than the payout rate for the regular bet. Accordingly, even when the second payout is given, reduction in profits of the manager side of the gaming machine can be suppressed. Further, since the second payout is based on the win/lose history, it is sometimes possible to improve player's motivation to continue, depending on a game history of the gaming machine. Therefore, new entertainmentness can be provided to the player while suppressing reduction in manager-side's profits, and moreover the manager-side's profits can be improved by making the player continue the game.

According to an aspect of the present invention, there is provided a playing method of a gaming machine using a display which displays thereon a plurality of betting objects selectable as a result of various events, and an input device by which a regular bet on the betting object, and a bonus bet on the betting object which is different in payout rate from the regular bet can be inputted from outside, as designated operations corresponding to the respective bets. The method including the steps of: setting a payout rate for the regular bet and a payout rate for the bonus bet, with respect to each betting object; receiving the regular bet or the bonus bet on the betting object as a player's bet, based on a designated operation inputted into the input device; determining whether the result of the event is consistent with the betting object or not; giving the player a first payout based on the player's bet, when it has been determined that the result of the event is consistent with the betting object; determining based on a predetermined condition whether a second payout which is different from the first payout should be given or not, when the player's bet is the bonus bet and the first payout has been given; and giving the player the second payout, when it has been determined that the second payout should be given.

In the method described above, a plurality of betting objects which are selectable as a result of various events are displayed on the display. A regular bet on the betting object, and a bonus bet on the betting object which is different in payout rate from the regular bet can be inputted from outside, by performing, on the input device, designated operations corresponding to the respective bets. A payout rate for the regular bet and a payout rate for the bonus bet are set with respect to each of the betting objects. Based on a designated operation inputted into the input device by a player, the regular bet or the bonus bet on the betting object is received as a player's bet. Whether the result of the event is consistent with the betting object or not is determined. When it has been determined that the result of the event is consistent with the betting object, a first payout based on the player's bet is given to the player. When the player's bet is the bonus bet and the first payout has been given, whether a second payout which is different from the first payout should be given or not is determined based on a predetermined condition. When it has been determined that the second payout should be given, the second payout is given to the player.

Therefore, simply by performing on the input device the designated operation corresponding to the bonus bet, the player can expect not only the first payout as a regular game result but also the second payout which can be given depending on determination based on the predetermined condition. This offers the player new entertainmentness.

### BRIEF DESCRIPTION OF THE DRAWINGS

FIG. 1 is an explanatory view showing an operation state of a sportsbook machine;

FIG. 2 is a block diagram of the sportsbook machine;

FIG. 3 is an explanatory view showing a display state of a bet amount display;

FIG. 4 is an explanatory view showing a display state of a betting object display;

FIG. 5 is an explanatory view showing a display state of a betting object display;

FIG. 6 is an explanatory view showing a display state of a betting object display;

FIG. 7 is a block diagram schematically showing a control system of the sportsbook machine;

FIG. 8 is a block diagram schematically showing a control system of a station;

FIG. 9 shows a betting object management table;

FIG. 10 shows a payout rate management table;

FIG. 11 shows an event result data table;

FIG. 12 shows a bet data table;

FIG. 13 is a flowchart showing a server-side data updating processing routine;

FIG. 14 is a flowchart showing a station-side display updating processing routine;

FIG. 15 is a flowchart showing a station-side bet receiving processing routine;

FIG. 16 is a flowchart showing a server-side bet receiving processing routine;

FIG. 17 is a flowchart showing a server-side event result determination processing routine;

FIG. 18 is a flowchart showing a station-side event payout giving processing routine; and

FIG. 19 is a flowchart showing a station-side bonus payout giving processing routine.

### DESCRIPTION OF THE PREFERRED EMBODIMENTS

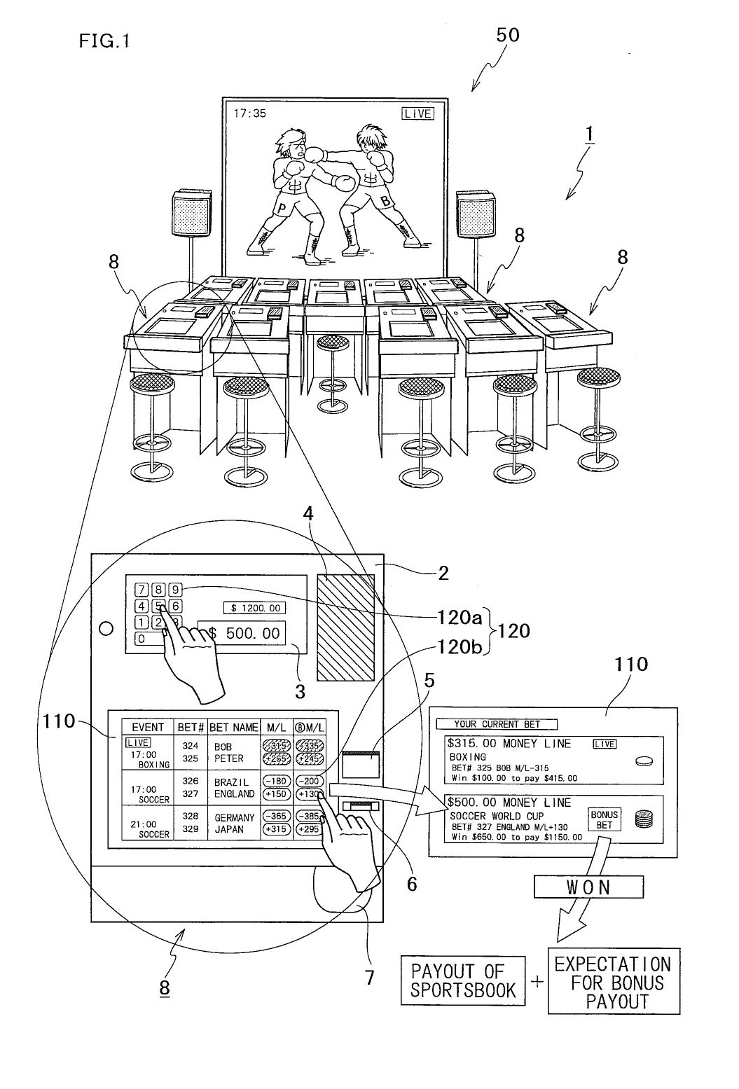

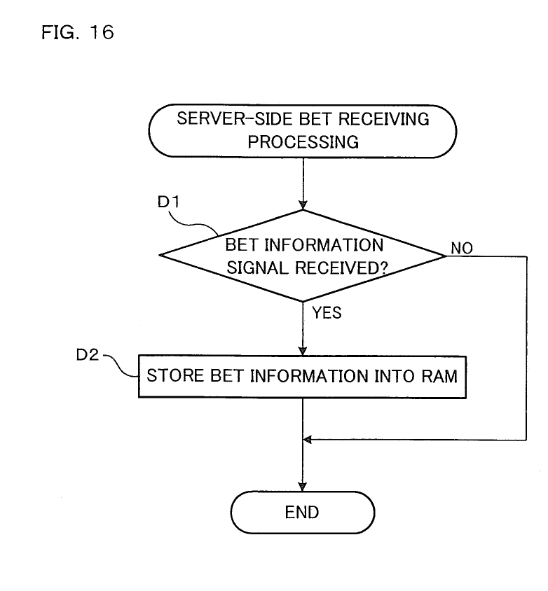

In the following, a gaming machine and a playing method thereof according to the present invention will be described with reference to FIGS. 1 to 19.

A gaming machine 10 (sportsbook machine 1) of this embodiment executes a so-called “book” game. The gaming machine 10 is adapted to execute a game in which two kinds of payouts can be expected by one bet on “book”.

In this embodiment, a coin, a bill, or electronic value information equivalent to them is used as a game medium for executing a game. In this embodiment, however, no particular limitation is put on the game medium. For example, medals, coins, token, electronic money, tickets, and the like may be adopted. In addition, no particular limitation is put on the ticket. For example, a barcoded ticket may be adopted.

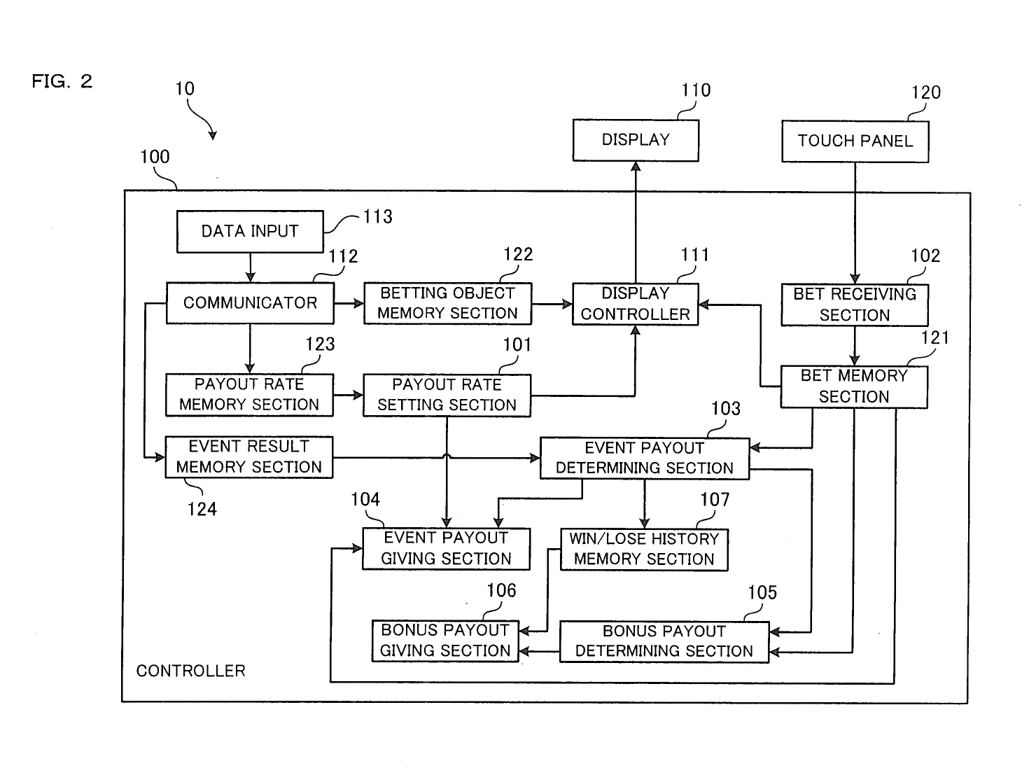

As shown in FIGS. 1 and 2, the gaming machine 10 (sportsbook machine 1) includes a display, an input device, and a controller. On the display, several betting objects which are selectable as a result of various events are displayed. By the input device, a regular bet on a betting object, and a bonus bet on a betting object which is different in payout rate from the regular bet can be inputted from outside as designated operations corresponding to the respective bets.

To be more specific, as shown in FIG. 2, the gaming machine 10 includes a display 110, a touch panel 120, a payout rate setting section 101, a bet receiving section 102, an event payout determining section 103, an event payout giving section 104, a bonus payout determining section 105, a bonus payout giving section 106, and a controller 100. On the display 110, several betting objects which are selectable as a result of various events are displayed. By the touch panel 120, a regular bet on a betting object, and a bonus bet on a betting object which is different in payout rate from the regular bet can be inputted from outside as designated operations corresponding to the respective bets. The payout rate setting section 101 sets a payout rate. The bet receiving section 102 receives a bet by a player. The event payout determining section 103 determines whether an event result is consistent with the betting object or not. The event payout giving section 104 gives a player an event payout as a first payout. The bonus payout determining section 105 determines whether a bonus payout as a second payout should be given or not. The bonus payout giving section 106 gives a player the second payout.

The controller 100 can execute a program which operates in following steps (a1) to (a6). In the step (a1), the payout rate setting section 101 sets a payout rate for a regular bet and a payout rate for a bonus bet, with respect to each betting object. In the step (a2), based on a designated operation inputted into the touch panel 120, the bet receiving section 102 receives a regular bet or a bonus bet on a betting object as a player's bet. In the step (a3), the event payout determining section 103 determines whether an event result is consistent with the betting object or not. In the step (a4), when it has been determined that the event result is consistent with the betting object, the event payout giving section 104 gives the player an event payout based on the player's bet. In the step (a5), when the player's bet is a bonus bet and the first payout has been given, the bonus payout determining section 105 determines based on a predetermined condition whether a bonus payout which is different from the event payout should be given or not. In the step (a6), when it has been determined that a bonus payout should be given, the bonus payout giving section 106 gives the player the bonus payout.

Here, the “gaming machine 10” may be of single-player type, or may be of multiplayer type. For example, by data-communicably connecting several “gaming machines 10” of single-player type, as a whole, several persons can participate.

The “display 110” may be mounted on each gaming machine 10, or may be a large-screen display which is shared by several gaming machines 10. Specific examples of the display 110 include a liquid crystal display device, a CRT (cathode-ray tube) device, a plasma display device, an organic EL (Electro-Luminescence) display device, and the like.

The “touch panel 120” may be one operated through a pen tablet, a joystick, a mouse and the like, or may be provided with an operation lever, an operation button, and the like.

The “various events” may be a variety of sports events such as boxing, baseball, soccer, and the like, which are played in many places. Alternatively, the “various events” may be virtual events executed on the gaming machine 10.

The “betting object”, the “payout rate”, and the “event result” may be directly inputted from outside to the gaming machine 10, or may be transmitted from an external server or the like via a communication channel. Alternatively, the gaming machine 10 may acquire them from the outside.

When the “event payout” is paid out, whether the “bonus payout” should be given or not is determined based on a predetermined condition. A jackpot may serve as the bonus payout. Here, the “jackpot” means accumulating a part of a game value bet, and giving a whole or a part of game values thus accumulated when a win occurs.

The gaming machine 10 having the above-described structure executes a playing method including the steps of: setting a payout rate for a regular bet and a payout rate for a bonus bet, with respect to each betting object; receiving the regular bet or the bonus bet on a betting object as a player's bet, based on a designated operation inputted into the touch panel 120; determining whether an event result is consistent with the betting object or not; giving a player an event payout based on the player's bet, when it has been determined that the event result is consistent with the betting object; determining based on a predetermined condition whether a bonus payout which is different from the event payout should be given or not, when the player's bet is a bonus bet and the event payout has been given; and giving the player the bonus payout, when it has been determined that the bonus payout should be given.

Therefore, simply by performing on the touch panel 120 the designated operation corresponding to the bonus bet, the player can expect not only the event payout as a regular game result but also the bonus payout which can be given depending on determination based on the predetermined condition. This offers the player new entertainmentness.

In addition, the gaming machine 10 is adapted to suppress reduction in manager-side's profits. As shown in FIG. 1, by the touch panel 120 of the gaming machine 1, a regular bet on a betting object and a bonus bet on a betting object which has a payout rate lower than the payout rate of the regular bet can be inputted from the outside as designated operations corresponding to the respective bets. The gaming machine 1 further includes the controller 100 programmed to operated in following steps (b1) to (b6).

In the step (b1), the payout rate setting section 101 sets a payout rate for a regular bet and a payout rate for a bonus bet, with respect to each betting object. In the step (b2), based on a designated operation inputted into the touch panel 120, the bet receiving section 102 receives a regular bet or a bonus bet on a betting object as a player's bet. In the step (b3), the event payout determining section 103 determines whether an event result is consistent with the betting object or not. In the step (a4), when it has been determined that the event result is consistent with the betting object, the event payout giving section 104 gives the player an event payout based on the player's bet. In the step (b5), when the player's bet is a bonus bet and the first payout has been given, the bonus payout determining section 105 determines at random whether a bonus payout which is different from the event payout should be given or not. In the step (b6), when it has been determined that a bonus payout should be given, the bonus payout giving section 106 gives the player the bonus payout.

Therefore, simply by performing on the touch panel 120 the designated operation corresponding to the bonus bet, the player can expect not only the event payout as a regular game result but also the bonus payout which can be given depending on random determination. The payout rate for the bonus bet (so-called odds) is set lower than the payout rate for the regular bet. Accordingly, even when the bonus payout is given, reduction in profits of the manager side of the gaming machine 10 can be suppressed. Like this, new entertainmentness can be provided to the player, while suppressing reduction in manager-side's profits.

Moreover, the gaming machine 10 is adapted to improve player's game continuity and also improve manager-side's profits. As shown in FIG. 2, the gaming machine 10 further includes a win/lose history memory section 107 which stores therein a result of determination made by the event payout determining section 103 as a win/lose history, and the controller 100 which is programmed to operate in following steps (c1) to (c7).

In the step (c1), the payout rate setting section 101 sets a payout rate for a regular bet and a payout rate for a bonus bet, with respect to each betting object. In the step (c2), based on a designated operation inputted into the touch panel 120, the bet receiving section 102 receives a regular bet or a bonus bet on a betting object as a player's bet. In the step (c3), the event payout determining section 103 determines whether an event result is consistent with the betting object or not. In the step (c4), the win/lose history memory section 107 stores a determination result as a win/lose history. In the step (c5), when it has been determined that the event result is consistent with the betting object, the event payout giving section 104 gives the player an event payout based on the player's bet. In the step (c6), when the player's bet is a bonus bet and the first payout has been given, the bonus payout determining section 105 determines based on a predetermined condition whether a bonus payout which is different from the event payout should be given or not. In the step (c7), when it has been determined that a bonus payout should be given, the bonus payout giving section 106 gives the player the bonus payout based on the win/lose history.

The “win/lose history” is a history of games played by the player on the gaming machine 10, and includes the total number of plays of the player, the total number of wins, the total number of loses, a total bet amount, a total win amount, a total lose amount, and the like. The “win/lose history memory section 107” may be a storage device provided within the gaming machine 10, a portable device carried by the player, or alternatively recorded on an IC card, a magnetic card, or the like.

Therefore, simply by performing on the touch panel 120 the designated operation corresponding to the bonus bet, the player can expect not only the event payout as a regular game result but also the bonus payout which can be given depending on a determination based on the predetermined condition. Since the bonus payout is based on the win/lose history, it is sometimes possible to improve player's motivation to continue the game, depending on a game history of the gaming machine 10. Consequently, new entertainmentness can be provided to the player, while improving manager-side's profits by making the player continue the game.

The gaming machine 10 is adapted to suppress reduction in manager-side's profits and also to improve the manager-side's profits by making the player continue the game. As shown in FIG. 2, in the gaming machine 10, by the touch panel 120 of the gaming machine 1, a regular bet on a betting object and a bonus bet on a betting object which has a payout rate lower than a payout rate of the regular bet can be inputted from the outside as designated operations corresponding to the respective bets. The gaming machine 1 further includes the win/lose history memory section 107 which stores therein a result of determination made by the event payout determining section 103, and the controller 100 which is programmed to operate in following steps (d1) to (d7).

In the step (d1), the payout rate setting section 101 sets a payout rate for a regular bet and a payout rate for a bonus bet, with respect to each betting object. In the step (d2), based on a designated operation inputted into the touch panel 120, the bet receiving section 102 receives a regular bet or a bonus bet on a betting object as a player's bet. In the step (d3), the event payout determining section 103 determines whether an event result is consistent with the betting object or not. In the step (d4), the win/lose history memory section 107 stores a determination result as a win/lose history. In the step (d5), when it has been determined that the event result is consistent with the betting object, the event payout giving section 104 gives the player an event payout based on the player's bet. In the step (d6), when the player's bet is a bonus bet and the first payout has been given, the bonus payout determining section 105 determines at random whether a bonus payout which is different from the event payout should be given or not. In the step (d7), when it has been determined that a bonus payout should be given, the bonus payout giving section 106 gives the player the bonus payout based on the win/lose history.

Therefore, simply by performing on the touch panel 120 the designated operation corresponding to the bonus bet, the player can expect not only the event payout as a regular game result but also the bonus payout which can be given depending on a determination based on the predetermined condition. In addition, since the payout rate for the bonus bet is set lower than the payout rate for the regular bet, reduction in profits of the manager side of the gaming machine can be suppressed even when the bonus payout is given. Moreover, since the bonus payout is based on the win/lose history, it is sometimes possible to improve player's motivation to continue the game, depending on a game history of the gaming machine. Therefore, new entertainmentness can be provided to the player while suppressing reduction in manager-side's profits, and moreover the manager-side's profits can be improved by making the player continue the game.

[Structure of Controller 100]

As shown in FIG. 2, the gaming machine 10 includes the display 110, the touch panel 120, and the controller 100. On the display 110, several betting objects which are selectable as a result of various events are displayed. By the touch panel 120, a regular bet on a betting object, and a bonus bet on a betting object which is different in payout rate from the regular bet can be inputted from outside as designated operations corresponding to the respective bets. The payout rate setting section 101 sets a payout rate. The bet receiving section 102 receives a bet by a player. The event payout determining section 103 determines whether an event result is consistent with the betting object or not. The event payout giving section 104 gives a player an event payout as a first payout. The bonus payout determining section 105 determines whether a bonus payout as a second payout should be given or not. The bonus payout giving section 106 gives a player the second payout.

The controller 100 includes the payout rate setting section 101, the bet receiving section 102, the event payout determining section 103, the event payout giving section 104, the bonus payout determining section 105, the bonus payout giving section 106, the win/lose history memory section 107, a display control section 111, a communication section 112, a data input section 113, a bet memory section 121, a betting object memory section 122, a payout rate memory section 123, and an event result memory section 124.

The payout rate setting section 101 sets payout rates corresponding to a regular bet and a bonus bet, based on the payout rates for the respective betting objects which are stored in the payout rate memory section 123. The payout rates thus set are displayed on the display 110.

The bet receiving section 102 is connected to the touch panel 120. The bet receiving section 102 has a function of receiving an operation signal from the touch panel 120, and recognizing the regular bet and the bonus bet to be displayed on the display 110, which are associated with operation position coordinates included in the operation signal, as designated operations corresponding to the respective bets. The bet receiving section 102 also recognizes a bet amount which is designated by the touch panel 120. Contents of the player's bet thus recognized are stored in the bet memory section 121.

The event payout determining section 103 compares the event result stored in the event result memory section 124 with the player's betting object stored in the bet memory section 121, and determines whether they are consistent with each other or not. A result of the determination is stored in the win/lose memory section 107, and also transmitted to the event payout giving section 104 and the bonus payout determining section 105.

The event payout giving section 104 gives the player an event payout based on the result of the determination by the event payout determining section 103, the payout rate set by the payout rate setting section 101, and the contents of the player's bet stored in the bet memory section 121. More specifically, when the event payout determining section 103 has determined that the event result and the player's betting object are consistent with each other, the event payout giving section 104 gives a game value as the event payout in accordance with the payout rate and the bet amount included in the contents of the bet.

The bonus payout determining section 105 gives the bonus payout based on the contents of the player's bet which are stored in the bet memory section 121, and the result of the determination by the event payout determining section 103. More specifically, when the designated operation which is included in the contents of the player's bet is a bonus bet and in addition the event payout determining section 103 has determined that the event result and the player's betting object are consistent with each other, the bonus payout determining section 105 randomly determines whether the bonus payout should be given or not. For giving the bonus payout, the bonus payout determining section 105 transmits a determination signal to the bonus payout giving section 106. Giving of the bonus payout may not necessarily be determined at random, and may be determined based on a predetermined condition.

When the determination signal is received from the bonus payout determining section 105, the bonus payout giving section 106 calculates a payout amount of the bonus payout based on the win/lose history of the player which is stored in the win/lose history memory section 107, and then gives the player a game value as the bonus payout.

The win/lose history memory section 107 stores therein a player's win/lose history based on the result of the determination by the event payout determining section 103, and the contents of the bet. The win/lose history is transmitted to the bonus payout giving section 106.

The display control section 111 controls contents to be displayed on the display 110. More specifically, the betting object stored in the betting object memory section 122, the payout rate set by the payout rate setting section 101, the bet contents stored in the bet memory section 121, and the like, are displayed.

The communication section 112 receives data which is inputted into the data input section 113. To be more specific, the communication section 112 stores, into the betting object memory section 122, betting object information which is inputted into the data input 113. Also, the communication section 112 stores, into the payout rate memory section 123, a payout rate which is inputted into the data input section 113. Also, the communication section 112 stores, into the event result memory section 124, an event result which is inputted into the data input section 113.

The data input 113 allows an input from the outside. The gaming machine 10 has a server 200, and a betting object, a payout rate for every betting object, and information about an event result, which are inputted into the data input section 113, can be received via the communication section 112.

The bet memory section 121 stores therein bet contents which are received by the bet receiving section 102. More specifically, the bet memory section 121 stores therein a player's betting object, whether a player's bet is a bonus bet or not, a bet amount on the betting object, and the like.

Each of the above-described blocks of the controller 100 may be formed of hardware, or may be formed of software if necessary.

[Operation of Controller 100]

The controller 100 having the above-described structure will be described. First, based on a payout rate and a betting object inputted into the data input 113, the payout rate setting section 101 sets a payout rate corresponding to the regular bet and a payout rate corresponding to the bonus bet. Then, the display control section 111 forms display contents to be displayed on the display 110, based on the betting object and the payout rate set. When the touch panel 120 is pressed by the player, the bet receiving section 102 recognizes a player's betting object, whether a player's bet is a bonus bet or not, and contents of the player's bet including a bet amount on the betting object, and stores them into the bet memory section 121.

When the event result is inputted into the data input section 113, the event payout determining section 103 compares the event result with the player's betting object to determine whether they are consistent or not. Then, the event payout determining section 103 stores a result of the determination into the win/lose history memory section 107. When they are consistent, the event payout giving section 104 gives the player an event payout based on the payout rate and the bet amount.

When the player's bet is the bonus bet and in addition the event payout has been given to the player, the bonus payout determining section 105 randomly determines whether a bonus payout should be given or not. More specifically, the bonus payout determining section 105 samples a random number, and determines whether a bonus payout should be given or not based on the random number. When the bonus payout determining section 105 has determined that a bonus payout should be given, the bonus payout giving section 106 gives the player a bonus payout based on a win/lose history stored in the win/lose history memory section 107.

[Mechanical Structure: Server 200]

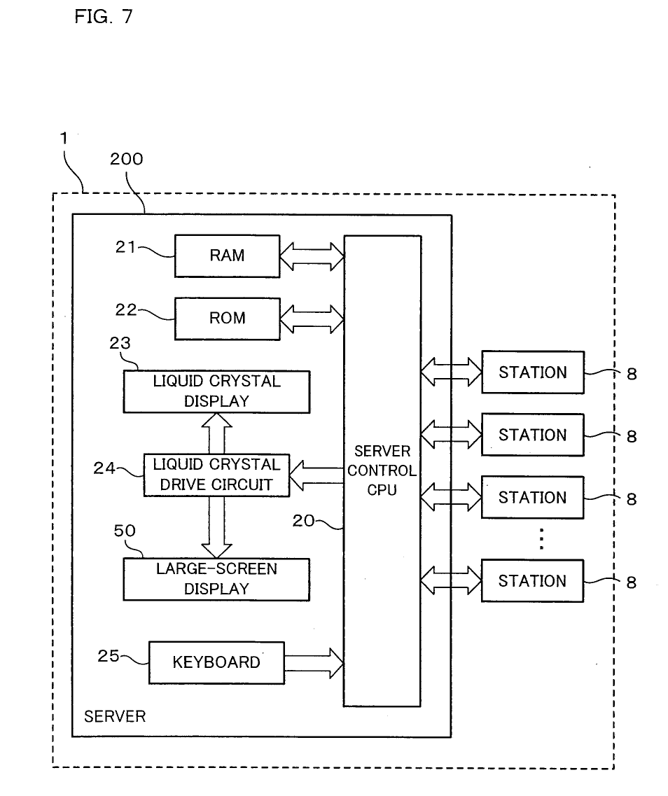

A specific description will be given to application of the gaming machine 10 to a sportsbook machine 1. FIG. 1 is an explanatory view showing a general structure of a sportsbook machine 1 of this embodiment, and an operation state of the sportsbook machine 1. As shown in FIG. 1, the sportsbook machine 1 includes several stations 8 which are placed in a game arcade, and a server 200 (see FIG. 7) which is connected to the respective station 8 data-communicably via a communication network.

The server 200 transmits a command signal to each station, thereby taking initiative in controlling each station 8, to progress a game. The server 200 has a large-screen display 50, which is provided in front of the stations 8 placed. The large-screen display 50 displays thereon a betting object event currently played.

As shown in FIG. 7, a liquid crystal display 23 and a keyboard 25 are connected to the server 200. The liquid crystal display 23 displays thereon a menu screen (not shown) and a maintenance screen (not shown). The keyboard 25 is an operation means on which several keys are provided. In addition to various settings in the sportsbook machine 1, a maintenance operation can be performed by a keeper operating the keyboard 25 while the menu screen or the maintenance screen is displayed on the liquid crystal display 23.

[Mechanical Structure: Station 8]

The station 8 has a cabinet 2, a bet amount display 3, a ticket printer 4, a bill insertion slot 5, a coin insertion slot 6, a payout opening 7, a betting object display 110, and a touch panel 120.

The cabinet 2 fixes, to predetermined positions, the bet amount display 3, the ticket printer 4, the bill insertion slot 5, the coin insertion slot 6, the payout opening 7, the betting object display 110, the touch panel 120, and the like.

The bet amount display 3 displays thereon a bet amount bet on a betting object by the player, images of number keys 0 to 9 which are so-called ten keys, and an image of an insertion amount. The betting object display 110 displays thereon several betting objects which are selectable as results of various events. The betting object display 110 displays thereon information about the betting object, in the form of an image.

The ticket printer 4 issues a voting ticket and a payout ticket. The voting ticket indicates contents of a player's bet. The payout ticket indicates an event payout and a bonus payout which are given as a bet result of the player. The voting ticket indicates bet contents such as a player's betting object, a bet amount, and the like.

To bet a desired bet amount, the player can insert bills and coins into the bill insertion slot 5 and the coin insertion slot 6, respectively. From the payout opening 7, a non-bet part of the inserted bills and coins is repaid, and also coins are paid out when paying back a small amount based on an event result.

The “voting ticket” is issued before the betting object event is finished. The “voting ticket” can be issued when, for example, the player leaves the station 8 during an event, and the like. When the player's betting object is won, the “voting ticket” can be exchanged for the payout or the like at a counter which is provided in the game arcade where the stations 8 are placed. Here, “winning” means that it is determined to give an event payout or an event payout and a bonus payout.

When the player wins, the “payout ticket” is issued as an event payout, or an event payout and a bonus payout. The “payout ticket” can be exchanged for the payout or the like at the counter.

The touch panel 120 functions as an input device by which the regular bet on a betting object, and the bonus bet on a betting object which is different in payout rate from the regular bet can be inputted from the outside as designated operations corresponding to the respective bets. The touch panel 120 has a bet amount touch panel 120a, and a betting object touch panel 120b. The bet amount touch panel 120a and the betting object touch panel 120b are so-called touch panels, and formed of a two-layer transparent electrode. The bet amount touch panel 120a and the betting object touch panel 120b can acquire position information of a pressed portion.

The bet amount touch panel 120a is mounted on a front face of the bet amount display 3. By acquiring a pressing on a displayed image of a number key as position information, the bet amount touch panel 120a recognizes a value corresponding to the position information, and it is displayed on the bet amount display 3.

The betting object touch panel 120b is mounted on a front face of the betting object display 110. By acquiring a pressing on a displayed image of a betting object as position information, the betting object touch panel 120b recognizes a betting object corresponding to the position information.

[Display State]

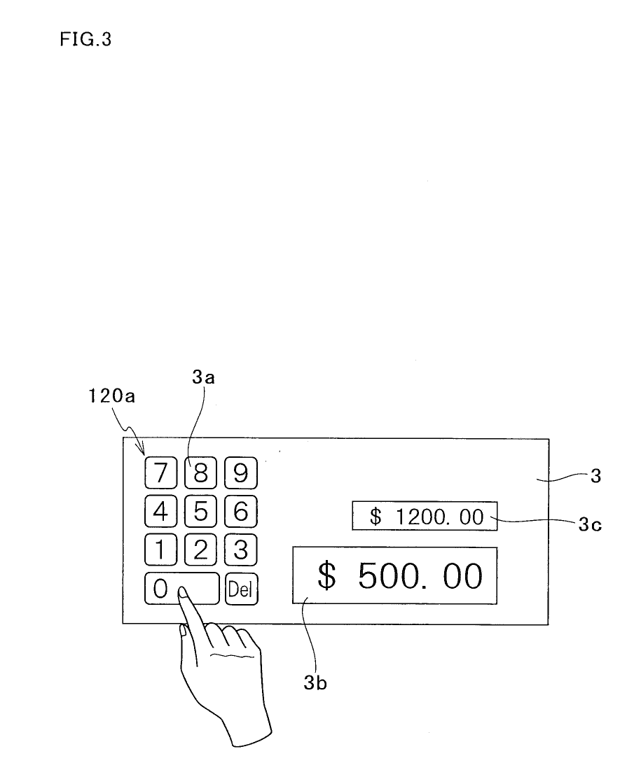

A specific description will be given to an example of a display state of the bet amount display 3 and the betting object display 110 in the station 8, with reference to FIGS. 3, 4, 5, and 6.

FIG. 3 is an explanatory view showing an image displayed on the bet amount display 3. The bet amount display 3 has a number key display region 3a, a bet amount display region 3b, and an insertion amount display region 3c.

As shown in FIG. 3, images of number keys 0 to 9 which are so-called ten keys are displayed in the number key display region 3a. The bet amount touch panel 120a is provided on a front face of the number key display region 3a, so that a value corresponding to each number can be inputted by pressing each number key image. A value image corresponding to a value which is inputted by pressing the bet amount touch panel 120a is displayed in the bet amount display region 3b. The player can bet a value displayed in the bet amount display region 3b, on a betting object. A value image indicating an amount inserted into the bill insertion slot 5 and the coin insertion slot 6 is displayed in the insertion amount display region 3c.

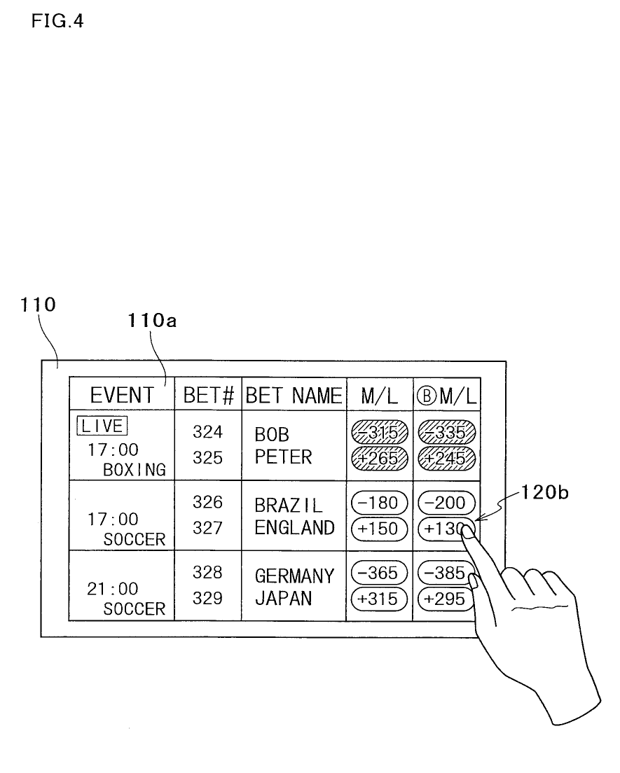

FIGS. 4, 5, 6, and 7 are explanatory views showing images displayed on the betting object display 110. As shown in FIG. 4, a betting object table image 110a is displayed on the betting object display 110. The betting object table image 110a shows a list of betting objects. The betting object table image 110a has an “EVENT” field, a “BET NUMBER” field, a “BET NAME” field, a “MONEYLINE” field, and a “MONEYLINE WITH BONUS” field.

In the “EVENT” field, start times of various events and names of various events are displayed. In the “EVENT” field, in addition, while an event is being held, letters of “LIVE” is displayed as an image, showing that the event is being held.

Several betting objects which are selectable as an event result are set for each of the various events. A unique number for uniquely identifying the betting object is displayed in the “BET NUMBER” field. A name of the betting object is displayed in the “BET NAME” field.

A payout rate for the regular bet which is set for every betting object is displayed in the “MONEYLINE” field. A payout rate for the bonus bet which is set for every betting object is displayed in the “MONEYLINE WITH BONUS” field.

The betting object touch panel 120b is mounted on the front face of the betting object display 110. By pressing an image indicating a payout rate in the “MONEYLINE” field and the “MONEYLINE WITH BONUS” field, the player can bet on a corresponding betting object. A bet amount bet at this time is an amount indicated by the value image which is displayed in the bet amount display region 3b.

When a bet cannot be made on a betting object event because the betting object event is currently in operation or the like, backgrounds of the images indicating the payout rates in the “MONEYLINE” field and the “MONEYLINE WITH BONUS” field are partially grayed out, showing that a bet cannot be accepted.

Here, the image “−180” in the “MONEYLINE” field means that an event payout of 100 dollars can be expected by betting 180 dollars. That is, by betting 180 dollars, 280 dollars are given upon a win. The image “+150” in the “MONEYLINE” field means that an event payout of 150 dollars can be expected by betting 100 dollars. That is, by betting 100 dollars, 250 dollars are given upon a win.

The image “−200” in the “MONEYLINE WITH BONUS” field means that an event payout of 100 dollars and a bonus payout can be expected by betting 200 dollars. That is, by betting 200 dollars, 300 dollars are given and in addition whether there is a bonus payout or not is determined at random, when a win occurs. The image “+130” in the “MONEYLINE WITH BONUS” field means that an event payout of 130 dollars and a bonus payout can be expected by betting 100 dollars. That is, by betting 100 dollars, 230 dollars are given and in addition whether there is a bonus payout or not is determined at random, when a win occurs.

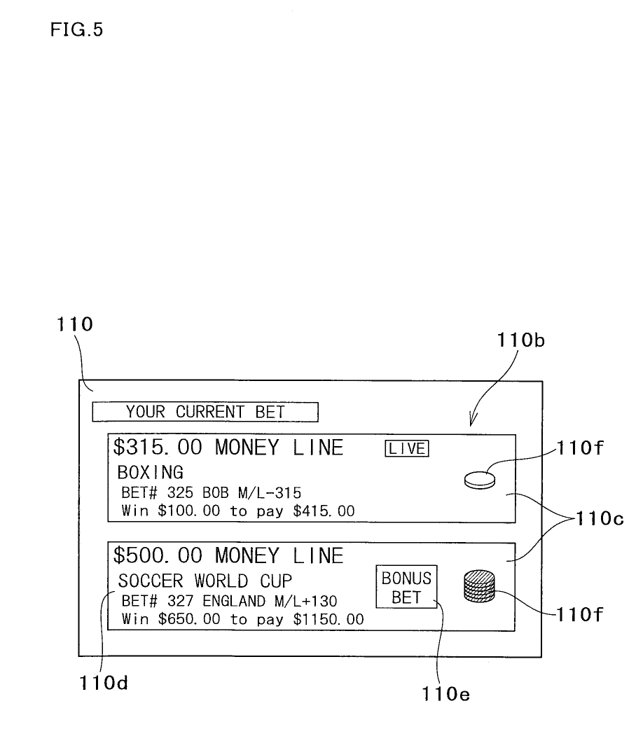

As shown in FIG. 5, a bet check image 110b is displayed on the bet amount display 3. When a player makes a bet, the bet check image 110b is displayed.

The bet check image 110b includes a betting object image 110c indicating a betting object on which the player has made a bet. The number of betting object images 110c shown in the bet check image 110b is the number of betting objects on which the player has made bets. In this embodiment, the betting object images 110, the number of which is equal to the number of betting object on which the player has made a bet, are displayed in one screen. However, it may be possible to switch several images from one to another to thereby display all the betting object images 110c.

The betting object image 110c has a betting object detail image 110d, a bonus image 110e, and a coin image 110f. The betting object detail image 110d indicates a bet amount on the player's betting object, an event name, a betting object name, a payout rate, a payout given upon a win, a payback given upon a win, and the like. When the player's bet is a bonus bet, a text image of “BONUS BET”, which indicates that the bet is a bonus bet, is displayed in the bonus image 110e.

In the coin image 110f, an image of coins the number of which corresponds to the bet amount bet by the player is displayed. Moreover, a color of the image of coins displayed in the coin image 110f varies depending on whether the player's bet is a regular bet or a bonus bet. Therefore, the player can easily understand his/her won bet contents. When the betting object on which the player has made a bet is won, an image indicating that a win occurs is displayed on the display 110, though not shown.

In the sportsbook machine 1, a bet can be made not only on various events actually played, but also on events virtually played in the sportsbook machine 1. While the various events are being held, the virtual events are executed. The virtual events are finished for a shorter time than the various events are. For example, the player can execute a virtual event while watching the various events on the large-screen display 50.

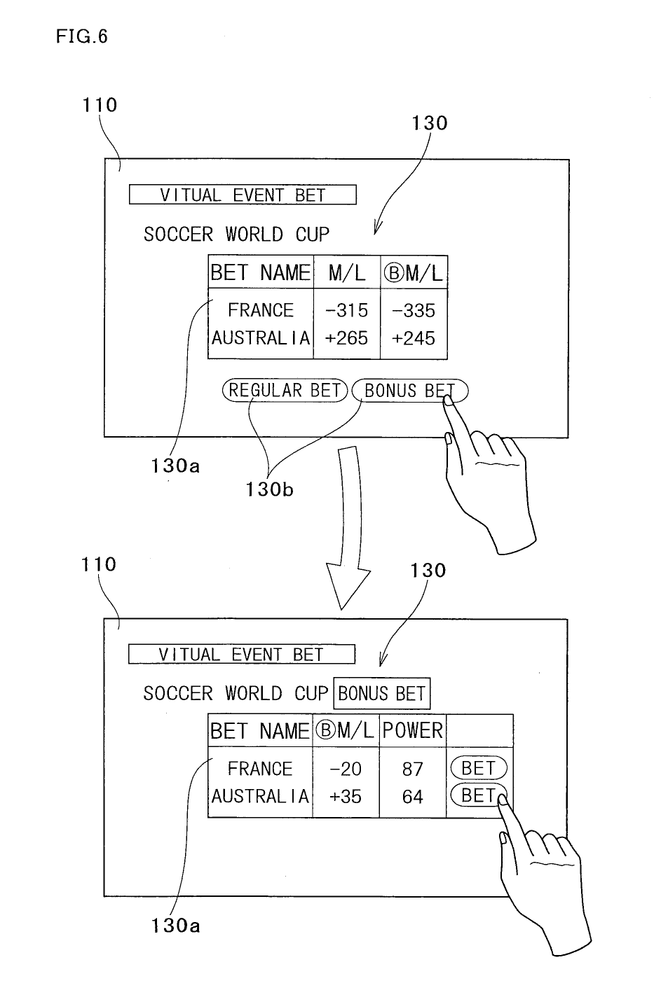

FIG. 6 is an explanatory view showing a bet screen for a virtual event. As shown in FIG. 6, a virtual event bet type selection screen 130, which includes a bet detail image 130a and a bet type image 130b, is displayed on the betting object display 110.

The bet detail image 130a has a betting object name, a payout rate for the regular bet, and a payout rate for the bonus bet. The bet type image 130b includes letter images indicating “REGULAR BET” and “BONUS BET”. By pressing either one of the letter images, the player can select a bet type. When the “BONUS BET” is selected, the bet is received as a bonus bet, as described above. When the bonus bet is won, an event payout is given and in addition giving of a bonus payout is determined at random.

When the bonus bet is selected, whether information about results of the virtual events should be displayed in the bet detail image 130a or not is determined at random. To be more specific, as shown by a lower part of FIG. 6, a winning probability for every betting object is indicated in the form of a value, as “POWER”. Here, the information about results of the virtual events is not limited to the above. Besides, the information about results of the virtual events may be displayed not only when the bonus bet has been selected. It may be displayed when the regular bet has been selected. Moreover, a probability that the information about results of the virtual events is displayed may be set higher when the bonus bet has been selected than when the regular bet has been selected.

When the player selects a bet type, letter images indicating “BET” are displayed for the respective betting objects in the bet detail image 130a. By pressing any one of the letter images, the player can bet on the betting object.

[Electrical Structure: Server 200]

FIG. 7 is a block diagram schematically showing a control system of the sportsbook machine 1. As shown in FIG. 7, the sportsbook machine 1 includes a server 200, and several stations 8 connected to the server 200. Details of a control system of the station 8 will be described later.

The server 200 includes a server control CPU 20, a RAM 21, a ROM 22, a large-screen display 50, a liquid crystal display 23, and a keyboard 25. The server control CPU 20 serves as a computing device and a control device which control a whole of the sever 200.

The server control CPU 20 executes a variety of processings, based on input signals supplied from the respective stations 8, and data or programs stored in the ROM 22 and the RAM 21. Thereby, the serve control CPU 20 transmits a command signal to the stations 8 based on execution results of the variety of processings, to initiatively control the respective stations 8, thereby progressing a game.

The ROM 22 is formed of a semiconductor memory or the like, for example. The ROM 22 stores therein a program for implementing basic functions of the sportsbook machine 1, a program for initiatively controlling the respective stations 8, and the like.

The RAM 21 temporarily stores therein the bet information supplied from the respective stations 8, data relating to a result of a processing executed by the server control CPU 20, and the like.

The RAM 21 has a betting object storage area in which a betting object is stored, a payout rate storage area in which a payout rate is stored, an event result storage area in which an event result is stored, and a bet storage area in which contents of a player's bet are stored.

[Electrical Structure: Station 8]

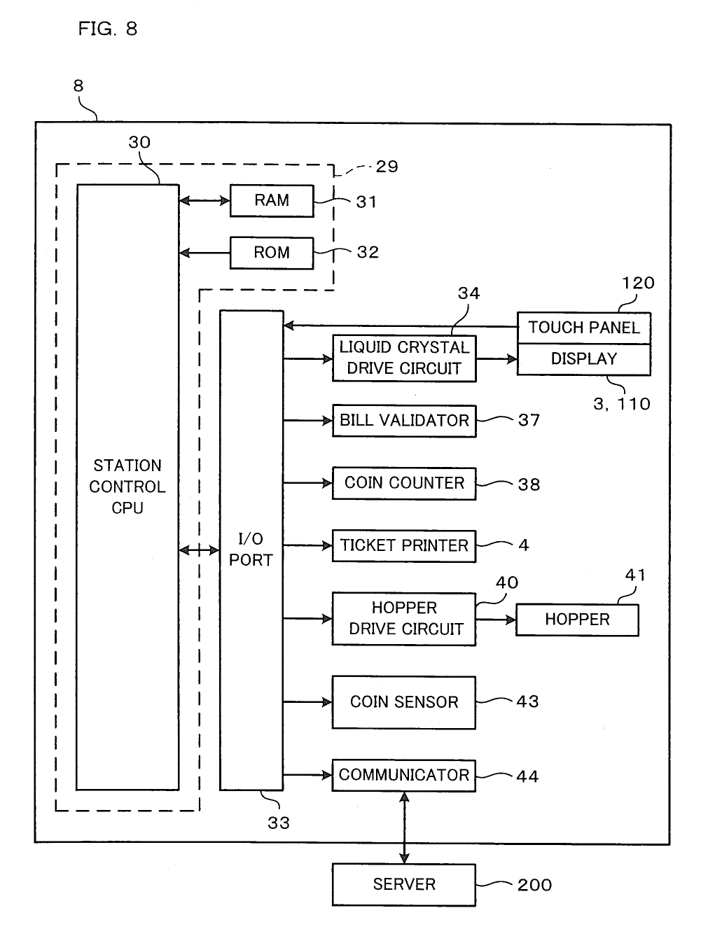

FIG. 8 is a block diagram schematically showing a control system of the station 8. In this embodiment, several placed stations 8 have the same structure. As shown in FIG. 7, the station 8 is made up of a station controller 29, an I/O port 33, and some peripheral devices connected through the I/O port 33. The station controller 29 includes a station control CPU 30, a ROM 32, and a RAM 31.

The ROM 32 is formed of a semiconductor memory or the like, for example. The ROM 32 stores therein a program for implementing basic functions of the station 8, various programs necessary for controlling the station 8, a data table, and the like. The RAM 31 is a memory for temporarily storing therein various data computed by the station control CPU 30, a credit value currently held by a player (reserved in the station 8), a state of betting chips by the player, and the like.

A liquid crystal drive circuit 34, a touch panel 120, a bill validator 37, a coin counter 38, a ticket printer 39, a hopper drive circuit 40, a coin sensor 43, and a communicator 44 are connected to the station control CPU 30 through the I/O port 33. Based on operation signals which are outputted by pressing on the touch panel 120, the station control CPU 30 makes controls to execute various operations corresponding thereto.

More specifically, upon an input of a pressing operation by the player, the station control CPU 30 executes various processings based on a position signal supplied from the touch panel 120 (the bet amount touch panel 120a, the betting object touch panel 120b), and data or programs stored in the ROM 32, RAM 31. The station control CPU 30 transmits a result of the execution from the communicator 20 to the above-described server control CPU 20 through a not-shown communication channel. On the other hand, the station control CPU 30 receives a command signal from the server control CPU 20, and controls the peripheral devices forming the station 8, to progress a game in the station 8. Depending on contents of the processing, the station control CPU 30 executes the various processings based on a position signal supplied from the touch panel upon an input of a player's operation, and data or programs stored in the ROM 32 and the RAM 31, controls the peripheral devices forming the station 8 based on a result of the execution, to progress a game in the station 8.

In addition, a hopper 41 is connected to the station control CPU 30 through a hopper drive circuit 40. The hopper 41 pays out a predetermined number of coins into the payout opening 7 in accordance with a command signal from the station control CPU 30. Furthermore, a display 3, 110 (the bet amount display 3, the betting object display 110) is connected to the station control CPU through the liquid crystal drive circuit 34. In regard to this, the liquid crystal drive circuit 34 is made up of a program ROM, an image ROM, an image control CPU, a work RAM, a VDP (video display processor), a video RAM, and the like. The program ROM stores therein an image control program which relates to display on the display 3, 110, a variety of selection tables, and the like.

In addition, the image ROM stores therein dot data for forming an image to be displayed on the display 3, 110, for example. Based on parameters set in the station control CPU 30, and in accordance with an image control program prestored in the program ROM, the image control CPU determines an image to be displayed on the display 3, 110, from the dot data prestored in the image RON. In addition, the work RAM is formed as a temporary memory means which is used when the image control program is executed in the image control CPU. In addition, the VDP forms an image corresponding to contents of display determined in the image control CPU, and outputs the image to the display 3, 110. In the mean time, the video RAM is formed as a temporary memory means which is used when an image is formed in the VDP.

In addition, a touch panel 120 is attached on a front face of the display 3, 110. Operation information of the touch panel 120 is transmitted to the station control CPU 30. On the touch panel 120, a player makes a bet operation. To be more specific, the touch panel 120 is operated for an input operation of a bet amount, selection of a betting object, and the like, and information thereof is transmitted to the station control CPU 30. Based on the information, current bet information of the player (a bet type, a betting object, a bet amount, and the like) is stored in the RAM 31. Furthermore, the bet information is transmitted to the server control CPU 20, and stored in the respective storage areas of the RAM 21.

Also, a coin sensor 43 is connected to the station control CPU 30. The coin sensor 43 detects coins inserted from the coin insertion slot 6, calculates the inserted coins, and transmits a result of calculation to the station control CPU 30. Based on a signal transmitted, the station control CPU 30 increases a credit value held by the player which is stored in the RAM 31.

The bill validator 37 reads an image of the bill inserted into the bill insertion slot 5, and accepts a proper bill into the cabinet 2. When a proper bill is accepted, the bill insertion slot 5 outputs an input signal to the station control CPU 30 based on an amount of the bill. Based on the signal transmitted, the station control CPU 30 increases a credit value held by the player which is stored in the RAM 31.

Based on a control signal output from the station control CPU 30, the ticket printer 4 prints, on a ticket, information based on bet contents stored in the RAM 31, and a barcode which is a coded form of the information, and outputs it as a voting ticket and a payout ticket.

Also, a not-shown lamp is connected to the station control CPU 30. When a betting object is won and the like, the station control CPU 30 lights the lamp in a predetermined display mode or the like, thereby improving a presentation effect.

[Data Table]

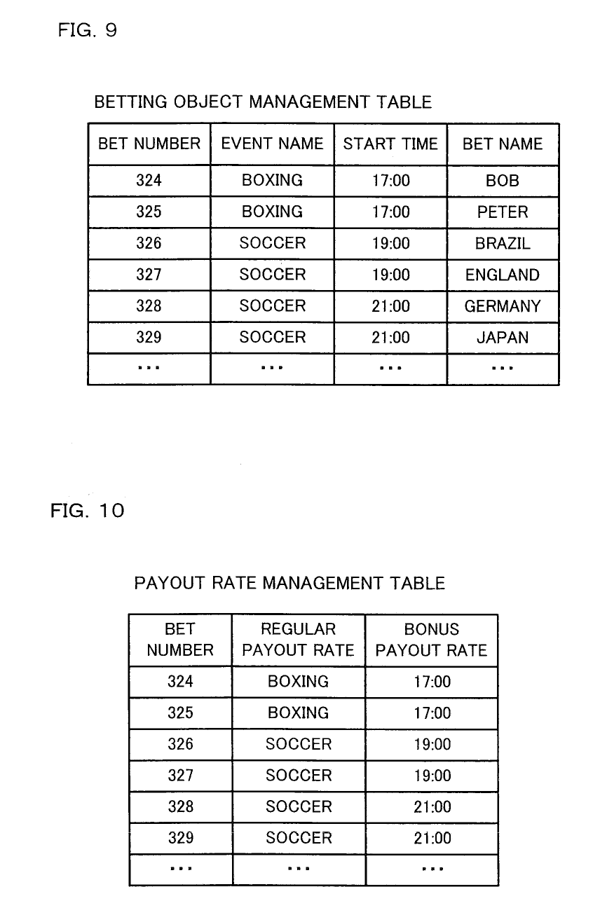

Next, a betting object management table shown in FIG. 9 will be described. Data of the betting object management table are stored in the RAM 21 of the server 200 shown in FIG. 7. The betting object management table has a bet number field, an event name field, a start time field, and a bet name field. In the bet number field, number data such as “1”, “2”, “3”, and the like, are stored. In the event name field, data indicating event names such as “BOXING”, “SOCCER”, and the like, are stored. In the start time field, event starting times are stored. In the bet name field, data indicating bet names such as “BOB”, “BRAZIL”, and the like, are stored. Data of the betting object management table are used for making a display on the display 110, and the like.

Next, a payout rate management table shown in FIG. 10 will be described. Data of the payout rate management table are stored in the RAM 21 of the server 200 shown in FIG. 7. The payout rate management table has a bet number field, a regular payout rate field, and a bonus payout rate field. In the bet number field, number data which correspond to the bet numbers stored in the betting object management table are stored. In the regular payout rate field, payout rates for regular bets on the betting objects corresponding to the respective bet numbers are stored. In the bonus payout rate field, payout rates for bonus bets on the betting objects corresponding to the respective bet numbers are stored. Data of the payout rate management table are used for making a display on the display 110, calculating a payout to be given, and the like.

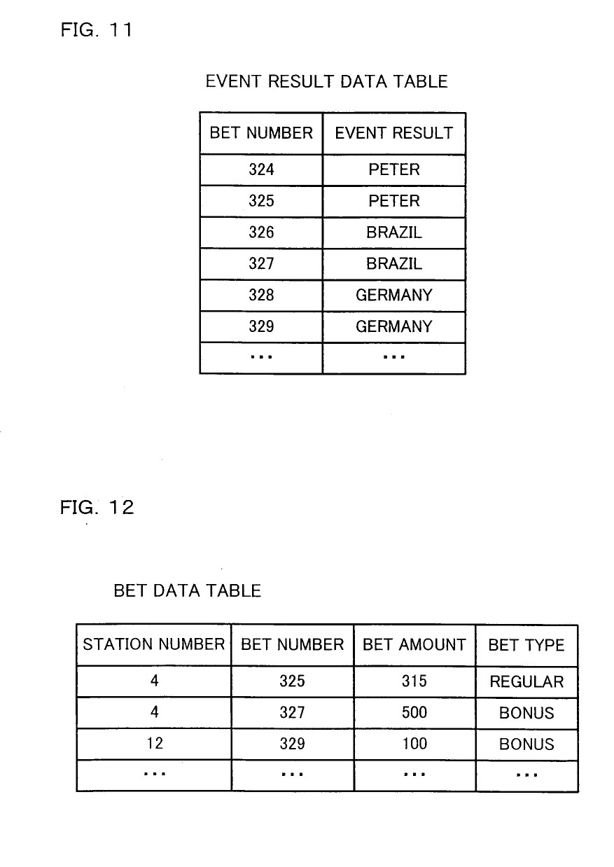

Next, an event result data table shown in FIG. 11 will be described. Data of the event result data table are stored in the RAM 21 of the server 200 shown in FIG. 7. The event result data table has a bet number field and an event result field. In the bet number field, number data which correspond to the bet numbers stored in the betting object management table are stored. In the event result field, a result of an event corresponding to a bet name is stored with respect to each betting object. Data of the event result data table are used for making a display on the display 110, determining giving of an event payout, and the like.

Next, a bet data table shown in FIG. 12 will be described. Data of the bet data table are stored in the RAM 31 of the station 8 shown in FIG. 8, and also the data are transmitted to the server 200 shown in FIG. 7 and then stored in the RAM 21. The bet data table has a station number field, a bet number field, a bet amount field, and a bet type field. In the station number field, unique numbers for uniquely identifying the respective stations 8 are stored. In the bet number field, number data which correspond to the bet numbers stored in the betting object management table are stored. In the bet amount field, amounts of bets made by the players are stored. In the bet type field, whether a player's bet is a regular bet or a bonus bet is stored. Data of the bet data table are used for making a display on the display 110, determining giving of an event payout and a bonus payout, and the like. These data tables may be stored in a storage device such as a hard disk which is connected to the outside of the server 200.

[Operation Processing]

Next, an operation in the sportsbook 1 will be described based on a server-side game processing program which is executed by the server control CPU 20, a station-side game processing program which is executed by the station control CPU 30 of the station 8 side, and the like. Respective programs shown by the following flowcharts are stored in the ROM 22 and the RAM 21 of the server 200 or the ROM 32 and the RAM 31 of the station 8, and executed by the server control CPU 20 or the station control CPU 30.

[Server-Side Data Update Processing]

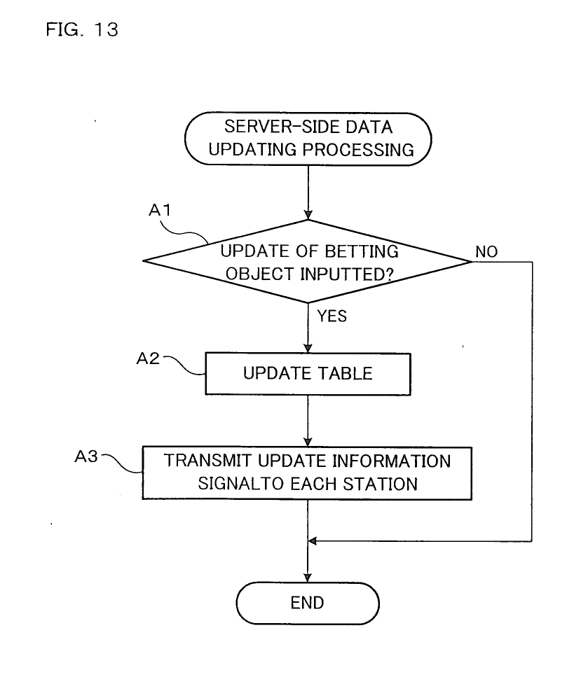

A server-side data updating processing in the server 200 will be described with reference to FIG. 13. First, whether an update of the betting object has been inputted by a keeper or not is determined (A1). To be more specific, in the server 200, whether betting object information and payout rate information have been added/changed by a keeper or the like operating the keyboard 25 or not is determined. Here, the input may not be limited to an input by operating the keyboard 25. For example, an update processing may be executed by a signal from an external server or the like which is connected to the server 200 through a communication channel.

When an update of the betting object has not been inputted (A1: NO), this routine ends. When an update of the betting object has been inputted (A1: YES), a table updating is performed (A2). More specifically, the betting object management table and the payout rate management table described above are updated based on information inputted. In the update of the payout rate, the payout rate for the regular bet and the payout rate for the bonus bet are set. In this embodiment, the payout rate for the bonus bet is set lower than the payout rate for the regular bet. However, this is not limitative, and different payout rates may be employed. Then, an update information signal including the above-described update information is transmitted to each of the stations 8 which are connected to the server 200 (A3), and this routine ends.

[Station-Side Display Update Processing]

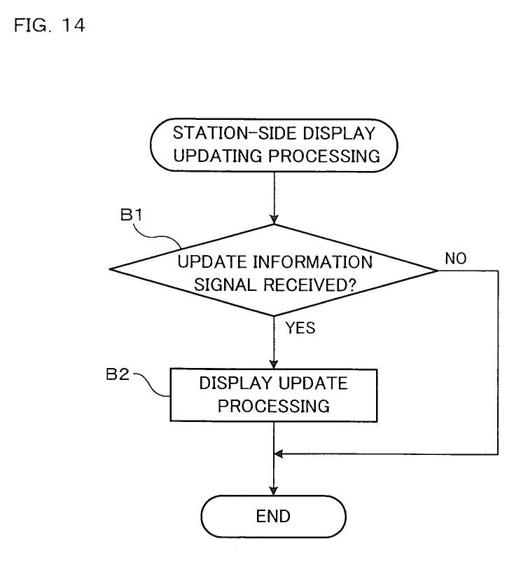

A station-side display updating processing in the station 8 will be described with reference to FIG. 14. First, whether an update information signal has been received from the server 200 or not is determined (B1). When an update information signal has not been received (B1: NO), this routine ends. When an update information signal has been received (B1: YES), a list of betting objects in the betting object table image 110a which is displayed on the betting object display 110 is updated based on the update information signal (B2), and this routine ends. Here, though not shown, this routine is executed every predetermined period, to compare a current time and an event start time with each other. When, as a result, the event start time is older than the current time, letters of “LIVE” are displayed at a corresponding event, and in addition a background of an image of a payout rate for a betting object corresponding to the event is partially grayed out.

[Station-Side Bet Receiving Processing]

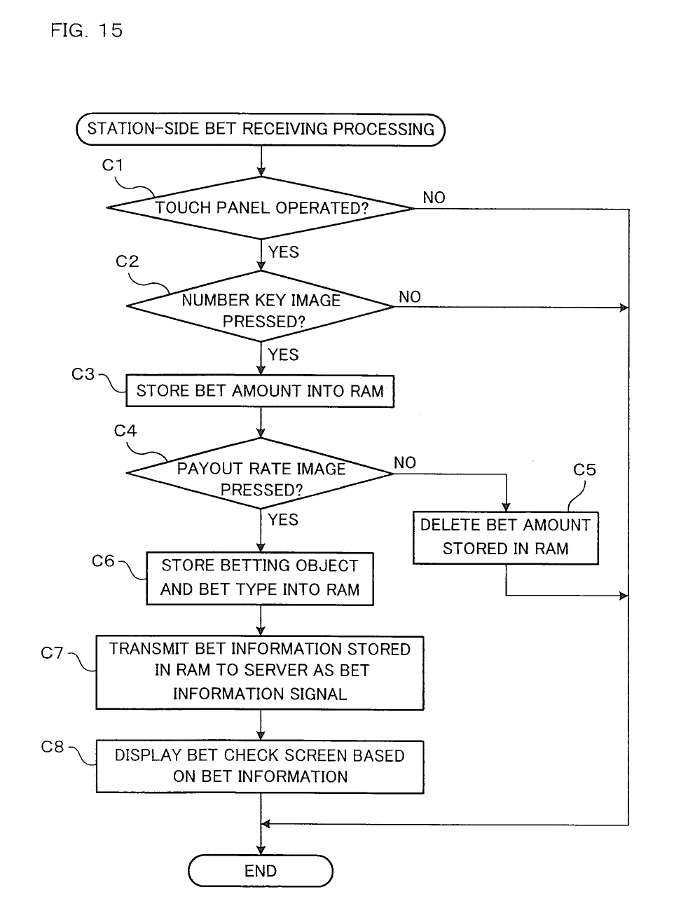

A station-side bet receiving processing in the station 8 will be described with reference to FIG. 15. First, whether the player operates the touch panel 120 or not is determined (C1). When the touch panel 120 is not operated (C1: NO), this routine ends. When the touch panel 120 is operated (C1: YES), whether the number key image has been pressed or not is determined (C2). To be more specific, whether the number key image on the bet amount touch panel 120a shown in FIG. 3 has been pressed to input a bet amount or not is determined. When the number key image has not been pressed (C2: NO), this routine ends. When the number key image has been pressed (C2: YES), a value inputted by the player's pressing is stored as a bet amount into the RAM 31 (C3).

Then, whether the payout rate image has been pressed or not is determined (C4). To be more specific, whether the payout rate image which is displayed for every betting object on the betting object touch panel 120b shown in FIG. 4 has been pressed or not is determined. When the payout rate image has not been pressed (C4: NO), the bet amount stored in the RAM 31 is deleted (C5), and this routine ends. When the payout rate image has been pressed (C4: YES), the betting object and the bet type are stored into the RAM 31 (C6). To be more specific, which betting object is indicated by position information inputted by the player's pressing is determined, and stored into the RAM 31. Further, which one of the regular bet and the bonus bet is indicated by the position information inputted by the player's pressing is determined, and stored into the RAM.

Then, bet information stored in the RAM 31 is, as a bet information signal, transmitted to the server 200 (C7). More specifically, bet information including a bet amount, a betting object, and a bet type stored in the RAM 31 is transmitted to the server 200, as a bet information signal. Then, a bet check screen shown in FIG. 5 is displayed based on the bet information (C8), and this routine ends. The bet information signal includes a station number of each station 8, which uniquely identifies the station 8. The station number is stored in the ROM 32.

[Server-Side Bet Receiving Processing]

A server-side bet receiving processing in the server 200 will be described with reference to FIG. 15. First, whether a bet information signal transmitted from the station 8 has been received or not is determined (D1). When a bet information signal has not been received (D1: NO), this routine ends. When a bet information signal has been received (D1: YES), bet information is stored into the RAM 21 (D2). More specifically, based on the bet information signal, a station number, a bet number which indicates a betting object, a bet amount, and a bet type are stored in the betting object management table shown in FIG. 12. Thus, a player's bet is received.

[Server-Side Event Result Determination Processing]

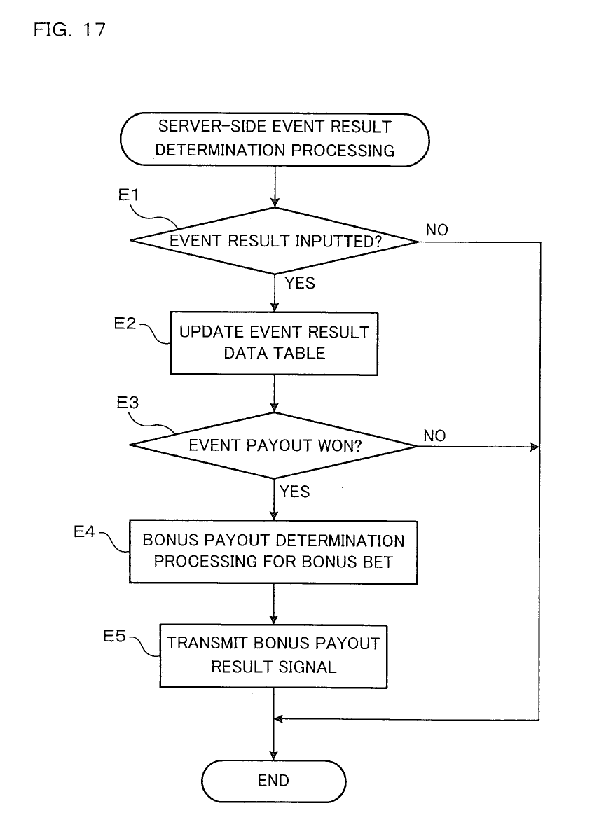

A server-side event result determination processing in the server 200 will be described with reference to FIG. 17. First, whether a keeper or the like has inputted an event result or not is determined (E1). Here, the input may not be limited to an input by operating the keyboard 25. For example, an update processing may be executed by a signal from an external server or the like which is connected to the server 200 through a communication channel. Here, the event result is inputted so as to correspond to the bet number and the bet name. However, this is not limitative. When an event result has not been inputted (E1: NO), this routine ends. When an event result has been inputted (E1: YES), the event result data table stored in the RAM 21 is updated (E2). Here, information of the event result data table may be used in giving a payout at a counter or the like.

Then, whether the player's bet has won an event payout or not is determined (E3). More specifically, the bet number inputted as the event result and the bet number stored in the bet data table are compared with each other. When the bet numbers are consistent as a result of comparison, the bet name corresponding to the bet number is acquired from the betting object management table. When the bet name inputted as the event result and the bet name thus acquired are consistent, it is determined that the player's bet has won. When the bet name inputted as the event result and the bet name thus acquired are inconsistent, it is determined that the player's bet has not won. A result of determination is, as an event determination result signal, transmitted to each station 8. The event determination result signal includes whether an event payout is won or not, and a payout amount which is given upon a win. The determination result is stored in the RAM 21 as a win/lose history of every player. However, this is not limitative.

When the player's bet has not won an event payout (E3: NO), this routine ends. When the player's bet has won an event payout (E3: YES), a bonus payout determination processing is executed for a bonus bet (E4). More specifically, whether a bonus payout, which is given when an event payout is won, will be given or not is determined at random. To be more specific, a random number table is stored in the ROM 22. In the random number table, whether a win occurs or not is determined in accordance with a value. One random number is determined by a program, and whether a bonus payout is won or not is determined with reference to the random number table. Here, although giving of the bonus payout is determined at random using a random number, this is not limitative. For example, it may also be possible to determine one player from several players who have participated in the same event, or to determine giving of the bonus payout based on another predetermined condition.

Then, a bonus payout result signal is transmitted to corresponding stations 8, respectively (E5), and this routine ends. The bonus payout result signal includes whether a bonus payout is won or not, and a payout amount which is given upon a win. The payout amount of the bonus payout is based on a win/lose history of every player which is stored in the RAM 21. Specifically, as the total number of loses of the player increases, the payout amount of the bonus payout rises by 1%. Here, the payout amount of the bonus payout is not limited thereto, and may be changed in accordance with a player's win/lose history such as the total number of plays made by the player, the total number of wins, the total number of loses, the total bet amount, the total won amount, the total lost amount, and the like. In addition, the payout amount of the bonus payout may not be based on the win/lose history, but may be determined depending on the number of persons who have participated in the corresponding event, for example.

[Station-Side Event Payout Giving Processing]

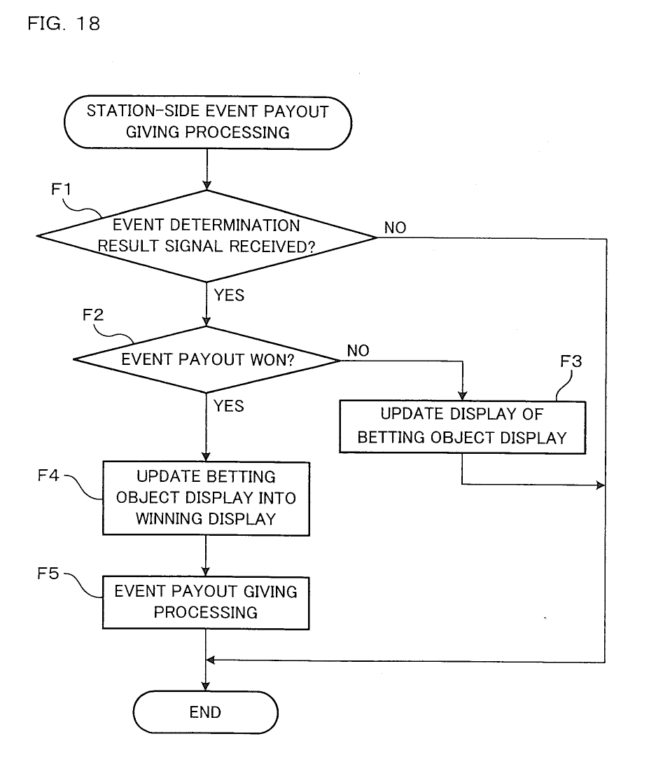

A station-side event payout giving processing in the station 8 will be described with reference to FIG. 18. First, whether an event determination result signal has been received from the server 200 or not is determined (F1). When an event determination result signal has not been received (F1: NO), this routine ends. When an event determination result signal has been received (F1: YES), whether an event payout has been won or not is determined based on the event determination result signal (F2). When an event payout has not been won (F2: NO), the betting object display 110 is updated into a display indicating that an event payout has not been won (F3), and this routine ends. When an event payout has been won (F2: YES), the betting object display 110 is updated into a display indicating that an event payout has been won (F4). Then, an event payout giving processing is executed (F5). More specifically, an event payout is given based on a payout amount of an event payout which is included in the event determination result signal.

[Station-Side Bonus Payout Giving Processing]

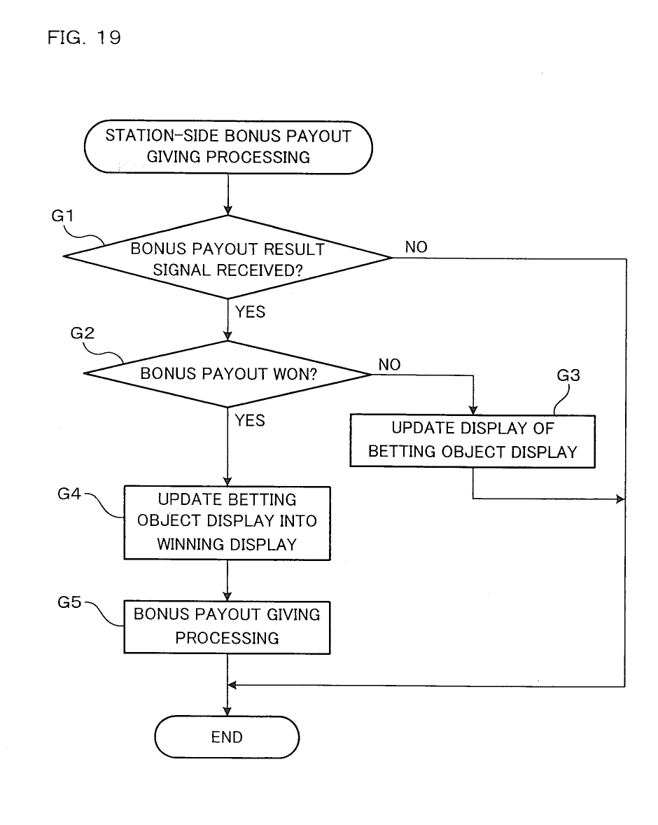

A station-side bonus payout giving processing in the station 8 will be described with reference to FIG. 19. First, whether a bonus payout result signal has been received from the server 200 or not is determined (G1). When a bonus payout result signal has not been received (G1: NO), this routine ends. When a bonus payout result signal has been received (G1: YES), whether a bonus payout has been won or not is determined based on the bonus payout result signal (G2). When a bonus payout has not been won (G2: NO), the betting object display 110 is updated into a display indicating that an bonus payout has not been won (G3), and this routine ends. When an event payout has been won (G2: YES), the betting object display 110 is updated into a display indicating that a bonus payout has been won (G4). Then, a bonus payout giving processing is executed (G5). More specifically, a bonus payout is given based on a payout amount of an event payout which is included in the bonus payout result signal.

In this embodiment, when an amount of the event payout and the bonus payout is equal to or smaller than 100 dollars, they are paid back from the payout opening 7. When an amount of the event payout and the bonus payout is greater than 100 dollars, a payout ticket is given by the ticket printer 4. Then, this routine ends. A way of payout is not limited to the above. It may also be possible that a player can select how to give a payout. In addition, a numeric value is not limited to the above-mentioned one.

In the detailed description provided above, characteristic parts have mainly been described in order that the present invention can be understood more easily. However, the present invention is not limited to the embodiment shown in the detailed description provided above, and may be applied to other embodiments. The scope of application of the present invention should be construed as broadly as possible. Terms and phraseologies adopted in the present specification are for correctly illustrating the present invention, not for limiting. It would be easy for those skilled in the art to derive, from the spirit of the invention described in the present specification, other structures, systems, methods and the like which are included in the spirit of the invention. Accordingly, it should be considered that claims cover equivalent structures, too, without departing from the technical idea of the present invention. An object of the abstract is to enable an intellectual property office, general public institutions, persons belonging to the art but not familiar with patent, legal terms, or technical terms to quickly understand technical contents and essences of the present invention through a simple research. Therefore, the abstract is not intended to limit the scope of the invention that should be evaluated by the claims. In addition, it is desirable to sufficiently refer to already-disclosed documents and the like, in order to fully understand the objects and effects of the present invention.

The detailed description provided above includes a processing which is executed on a computer or a computer network. The descriptions and expressions provided above are given for the purpose of allowing those skilled in the art to understand the invention most effectively. In the specification, respective steps used to induce one result, or blocks having a predetermined processing function should be understood as a processing having no self-contradiction. In addition, in each step or block, an electrical or magnetic signal is transmitted/received, recorded, and the like. In a processing in each step or block, such a signal is embodied in the form of a bit, a value, a symbol, a character, a term, a number, and the like. However, it should be noted that they have been used simply because they are convenient for explanations. A processing in each step or block has sometimes been described using an expression which is common to a human behavior. However, in principle, the processing described in the specification is executed by a variety of devices. In addition, other structures necessary for each step or block are apparent from the above description.

What is claimed is:

1. A gaming machine comprising:
a display which displays thereon a plurality of betting objects selectable as a result of various events;
an input device by which a regular bet on the betting object, and a bonus bet on the betting object which is different in payout rate from the regular bet can be inputted from outside, as designated operations corresponding to the respective bets; and
a controller which is programmed to operate in the following steps of:
(a1) setting a payout rate for the regular bet and a payout rate for the bonus bet, with respect to each of the betting objects;
(a2) receiving the regular bet or the bonus bet on the betting object as a player's bet, based on a designated operation inputted into the input device;
(a3) determining whether the result of the event is consistent with the betting object or not;
(a4) giving the player a first payout based on the player's bet, when it has been determined that the result of the event is consistent with the betting object;
(a5) determining based on a predetermined condition whether a second payout which is different from the first payout should be given or not, when the player's bet is the bonus bet and the first payout has been given; and
(a6) giving the player the second payout, when it has been determined that the second payout should be given.

2. A gaming machine comprising:
a display which displays thereon a plurality of betting objects selectable as a result of various events;
an input device by which a regular bet on the betting object, and a bonus bet on the betting object which has a payout rate lower than the payout rate of the regular bet can be inputted from the outside, as designated operations corresponding to the respective bets; and
a controller which is programmed to operate in the following steps of:
(b1) setting a payout rate for the regular bet and a payout rate for the bonus bet, with respect to each of the betting objects;
(b2) receiving the regular bet or the bonus bet on the betting object as a player's bet, based on a designated operation inputted into the input device;
(b3) determining whether the result of the event is consistent with the betting object or not;
(b4) giving the player a first payout based on the player's bet, when it has been determined that the result of the event is consistent with the betting object;
(b5) determining at random whether a second payout which is different from the first payout should be given or not, when the player's bet is the bonus bet and the first payout has been given; and
(b6) giving the player the second payout, when it has been determined that the second payout should be given.

3. A gaming machine comprising:
a display which displays thereon a plurality of betting objects selectable as a result of various events;
an input device by which a regular bet on the betting object, and a bonus bet on the betting object which is different in payout rate from the regular bet can be inputted from outside, as designated operations corresponding to the respective bets; and
a controller which is programmed to operate in the following steps of:
(c1) setting a payout rate for the regular bet and a payout rate for the bonus bet, with respect to each of the betting objects;
(c2) receiving the regular bet or the bonus bet on the betting object as a player's bet, based on a designated operation inputted into the input device;
(c3) determining whether the result of the event is consistent with the betting object or not;
(c4) storing a determination result as a win/lose history;
(c5) giving the player a first payout based on the player's bet, when it has been determined that the result of the event is consistent with the betting object;
(c6) determining based on a predetermined condition whether a second payout which is different from the first payout should be given or not, when the player's bet is the bonus bet and the first payout has been given; and
(c7) giving the player the second payout based on the win/lose history, when it has been determined that the second payout should be given.

4. A gaming machine comprising:
a display which displays thereon a plurality of betting objects selectable as a result of various events;
an input device by which a regular bet on the betting object, and a bonus bet on the betting object which has a payout rate lower than the payout rate of the regular bet can be inputted from the outside, as designated operations corresponding to the respective bets; and
a controller which is programmed to operate in the following steps of:
(d1) setting a payout rate for the regular bet and a payout rate for the bonus bet, with respect to each of the betting objects;
(d2) receiving the regular bet or the bonus bet on the betting object as a player's bet, based on a designated operation inputted into the input device;
(d3) determining whether the result of the event is consistent with the betting object or not;
(d4) storing a determination result as a win/lose history;
(d5) giving the player a first payout based on the player's bet, when it has been determined that the result of the event is consistent with the betting object;
(d6) determining at random whether a second payout which is different from the first payout should be given or not, when the player's bet is the bonus bet and the first payout has been given; and
(d7) giving the player the second payout based on the win/lose history, when it has been determined that the second payout should be given.

5. A playing method of a gaming machine using a display which displays thereon a plurality of betting objects selectable as a result of various events, and an input device by which a regular bet on the betting object, and a bonus bet on the betting object which is different in payout rate from the regular bet can be inputted from outside, as designated operations corresponding to the respective bets,
the method including the steps of:
setting a payout rate for the regular bet and a payout rate for the bonus bet, with respect to each betting object;
receiving the regular bet or the bonus bet on the betting object as a player's bet, based on a designated operation inputted into the input device;
determining whether the result of the event is consistent with the betting object or not;
giving the player a first payout based on the player's bet, when it has been determined that the result of the event is consistent with the betting object;
determining based on a predetermined condition whether a second payout which is different from the first payout should be given or not, when the player's bet is the bonus bet and the first payout has been given; and
giving the player the second payout, when it has been determined that the second payout should be given.
